(19) United States
(12) Patent Application Publication
(10) Pub. No.: US 2018/0156552 A1
(43) Pub. Date: Jun. 7, 2018

(54) THERMAL SIMULATION SYSTEM

(71) Applicants: Chang-Yu Tu, Taipei City (TW); Te-Ming Kung, Taipei City (TW); Wen-Shyan Lai, Taipei City (TW); Tung-Hua Wu, Taipei City (TW)

(72) Inventors: Chang-Yu Tu, Taipei City (TW); Te-Ming Kung, Taipei City (TW); Wen-Shyan Lai, Taipei City (TW); Tung-Hua Wu, Taipei City (TW)

(73) Assignee: COMPAL ELECTRONICS, INC., Taipei City (TW)

(21) Appl. No.: 15/832,699

(22) Filed: Dec. 5, 2017

Related U.S. Application Data
(60) Provisional application No. 62/430,885, filed on Dec. 6, 2016.

(51) Int. Cl. F28F 27/00; G01K 17/20

(52) U.S. Cl. CPC F28F 27/00; F28F 2200/00; G01K 17/20

(57) ABSTRACT

A thermal simulation system adapted to establish a test environment for a thermal test is provided. The thermal simulation system includes a communication element, a controllable loading element, a plurality of connectors, and a controller. The communication element is configured to receive at least one of a heating control signal, a fan control signal, and a loading control signal from an external electronic device. The controllable loading element is configured to provide a loading. The connectors are configured to connect a heating element and a fan. The controller is configured to control a heat energy generated by the heating element according to the heating control signal, control a fan speed of the fan according to the fan control signal, and control a loading value of the loading provided by the controllable loading element according to the loading control signal.

### CROSS-REFERENCE TO RELATED APPLICATION

This application claims the priority benefits of U.S. provisional application Ser. No. 62/430,885, filed on Dec. 6, 2016. The entirety of the above-mentioned patent application is hereby incorporated by reference herein and made a part of this specification.

### BACKGROUND

### Technical Field

The invention relates to a test tool, and more particularly, relates to a thermal simulation system configured for testing heat dissipation capacity of a device.

### Description of Related Art

In recent years, with advances in the technology industry, electronic devices, such as personal computers (PCs), notebooks (NBs), personal digital assistants (PDAs), smart phones, and other products have become a major role in everyday life. Heat energy is generated most of the time when the electronic devices operate, and operational efficiency of the electronic devices is thereby affected. A heat dissipation module or a heat dissipation element (e.g., a heat dissipation fan) is thereby disposed in an electronic device most of the time to facilitate heat dissipation of heat generated in the electronic device to the external environment.

When designing the heat dissipation module or the heat dissipation element in the electronic device, a comprehensive test process is required to ensure heat dissipation efficiency. In an existing test method, a usage rate of a central processing unit or a graphics card in the electronic device is increased for generating heat. Nevertheless, the heat generated through such test method can not be accurately controlled, and test efficiency of heat dissipation can not be further enhanced as a result.

### SUMMARY

The invention provides a thermal simulation system capable of accurately providing a test environment required by testing personnel.

In an embodiment of the invention, a thermal simulation system is provided and is adapted to establish a test environment for a thermal test. The thermal simulation system includes a communication element, a controllable loading element, a plurality of connectors, and a controller. The controller is coupled to the communication element, the controllable loading element, and the connectors. The communication element is configured to receive at least one of a heating control signal, a fan control signal, and a loading control signal from an external electronic device. The controllable loading element is configured to provide a loading. The connectors are configured to connect a heating element and a fan. The controller is configured to control a heat energy generated by the heating element according to the heating control signal, control a fan speed of the fan according to the fan control signal, and control a loading value of the loading provided by the controllable loading element according to the loading control signal.

In an embodiment of the invention, a thermal simulation system is provided and is adapted to establish a test environment for a thermal test. The thermal simulation system includes a first communication element, a first connector, and a first controller. The first controller is coupled to the first communication element and the first connector. The first communication element is configured to receive a heating control signal from an external electronic device. The first connector is configured to connect a heating element. The first controller is configured to control a heat energy generated by the heating element according to the heating control signal.

In an embodiment of the invention, a thermal simulation system is provided and is adapted to establish a test environment for a thermal test. The thermal simulation system includes a first communication element, a controllable loading element, and a first controller. The first controller is coupled to the first communication element and the controllable loading element. The first communication element is configured to receive a loading control signal from an external electronic device. The controllable loading element is configured to provide a loading. The first controller is configured to control a loading value of the loading provided by the controllable loading element according to the loading control signal.

To sum up, in the thermal simulation system provided by the embodiments of the invention, the controller is used to respectively control the fan, the temperature sensor, the heating element, and the controllable loading element, so as to more accurately control the fan speed of the fan, the heat energy generated by the heating element, and the loading value of the loading provided by the controllable loading element when thermal testing is performed in the system. Accordingly, the testing personnel may create the test environment required more conveniently.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 illustrates a schematic block diagram of a thermal simulation system according to an embodiment of the invention.

FIG. 2 illustrates a schematic diagram of a thermal simulation system according to an embodiment of the invention.

FIG. 3 illustrates a schematic diagram of a thermal simulation system according to an embodiment of the invention.

FIG. 4 illustrates a schematic view of a fan control device according to an embodiment of the invention.

FIG. 5 illustrates a schematic view of a heating device according to an embodiment of the invention.

FIG. 6 illustrates a schematic view of a loading device according to an embodiment of the invention.

### DESCRIPTION OF THE EMBODIMENTS

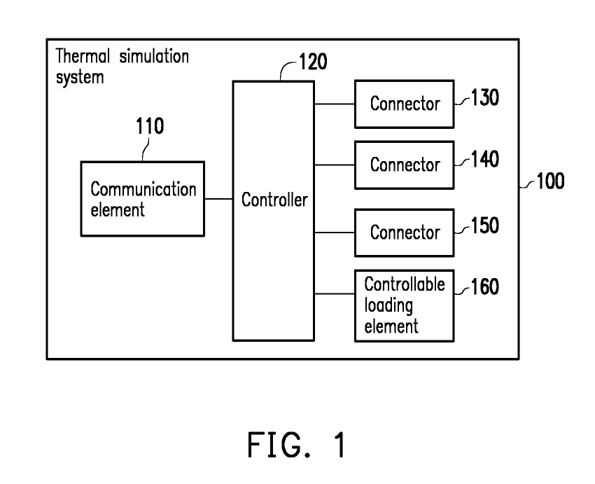

FIG. 1 illustrates a schematic block diagram of a thermal simulation system according to an embodiment of the invention.

With reference to FIG. 1, a thermal simulation system 100 of this embodiment includes a communication element 110, a controller 120, a plurality of connectors 130, 140, and 150, and a controllable loading element 160. The controller 120 is coupled to the communication element 110, the connectors 130, 140, and 150, and the controllable loading element 160. In this embodiment, the thermal simulation system 100 is disposed in a tested system (not shown) by testing personnel, for example, so as to simulate a test environment required in the tested system.

In this embodiment, the communication element 110 is, for example but not limited to, one of the communication modules such as the wired Universal Serial Bus (USB), wireless bluetooth, infrared (RF), Wireless Fidelity (Wi-Fi), or a combination of the foregoing, so as to perform wired or wireless communication with an external electronic device.

In this embodiment, the controller 120 is, for example but not limited to, a central processing unit (CPU), a programmable microprocessor for general or special use, a digital signal processor (DSP), a programmable controller, an application specific integrated circuit (ASIC), a programmable logic device (PLD), other similar device, or a combination of the foregoing devices.

In this embodiment, the connector 130 is, for example, configured to connect at least one fan; the connector 140 is, for example, configured to connect at least one temperature sensor; the connector 150 is, for example, configured to connect at least one heating element. For instance, the fans connected to the connector 130 may be respectively disposed at arbitrary positions in the tested system for heat dissipation by the testing personnel according to test requirements. The temperature sensors connected to the connector 140 may be respectively disposed at arbitrary positions in the tested system for testing temperatures of the positions in which the temperature sensors are located. The heating elements connected to the connector 150 may be respectively disposed at arbitrary positions in the tested system for increasing temperatures of the positions in which the heating elements are located.

The controllable loading element 160, for example, is formed by one or a plurality of resistors for providing a loading in this embodiment.

Particularly, the controller 120 may directly control a fan speed of each of the fans connected thereto through the connector 130; directly control a heat energy generated by each of the heating elements connected thereto through the connector 140; and read a read value of each of the temperature sensors through the connector 150. In addition, the controller 120 may directly adjust a loading value of the loading provided by the controllable loading element 160. As such, the thermal simulation system 100 provided by the embodiments of the invention may accurately create a test environment required in the tested system.

In some embodiments, the tested system, for example, is placed and tested in a vacuum chamber. Through the thermal simulation system 100 introduced in FIG. 1, the test personnel only have to preset the positions of the fans, the temperature sensors, and the heating elements, and the communication element 110 may then be wirelessly connected to by using an electronic device. The controller 120 is then further controlled to conveniently establish the test environment required and to read the read values of the temperature sensors.

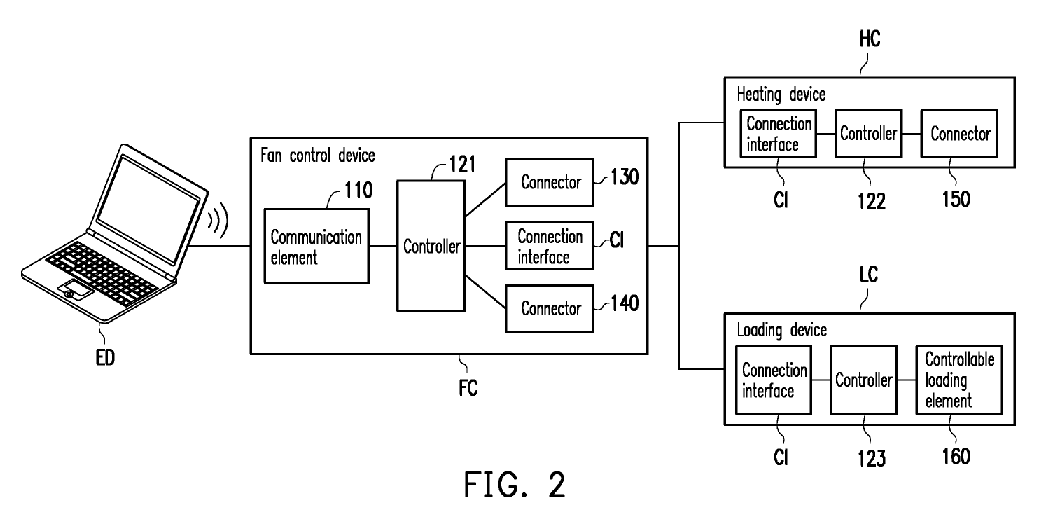

FIG. 2 illustrates a schematic diagram of a thermal simulation system according to an embodiment of the invention.

With reference to FIG. 2, an implementation of the thermal simulation system 100 in the embodiment of FIG. 1 is exemplarily introduced in this embodiment. Reference numerals in this embodiment which are the same as or similar to those in the previous embodiment are used to represent identical or similar elements, and thus, no further description is provided hereinafter.

In this embodiment, the thermal simulation system 100 includes a fan control device FC, a heating device HC, and a loading device LC respectively controlled by a controller 121, a controller 122, and a controller 123. Moreover, the controller 121, the controller 122, and the controller 123 are coupled to and communicate with each other through connection interfaces CI. In this embodiment, the controller 121, the controller 122, and the controller 123, for example, are similar to the controller 120 in the embodiment of FIG. 1, and the connection interface CI, for example, is an inter-integrated circuit (I²C), a serial advanced technology attachment (SATA), or a parallel advanced technology attachment (PATA), etc. It is noted that the invention is not limited to the above.

The fan control device FC includes the communication element 110, the controller 121, the connector 130, the connector 140, and the connection interface CI in this embodiment. The controller 121 is coupled to the communication element 110, the connector 130, the connector 140, and the connection interface CI.

In an embodiment, the fan control device FC, for example, is implemented in a form of a PCIe card, so as to be conveniently disposed on a mainboard (also known as motherboard) of the tested system. To be specific, the communication element 110, the controller 121, the connector 130, the connector 140, and the connection interfaces CI are all disposed on the PCIe card, and the PCIe card may be inserted and disposed on the mainboard through a PCIe connector thereof. Accordingly, if a power supply is provided in the tested system to provide power to the mainboard, the fan control device FC may also obtain power through the PCIe connector. A power port configured to be connected to an external power source may further be included on the PCIe card in an embodiment. As such, each of the elements on the PCIe card may also obtain necessary power from the external power source through the power port. Nevertheless, the invention sets no limit herein to the form that the fan control device FC is implemented in.

In this embodiment, the heating device HC includes the controller 122, the connector 150, and the connection interface CI, wherein the controller 122 is coupled to the connector 150 and the connection interface CI.

In an embodiment, the heating device HC, for example, is implemented in the form of the PCIe card, so as to be conveniently disposed on the mainboard of the tested system. To be specific, the controller 122, the connector 150, and the connection interface CI are all disposed on the PCIe card, and the PCIe card may be inserted and disposed on the mainboard through the PCIe connector thereof. Accordingly, if a power supply is provided in the tested system to provide power to the mainboard, the heating device HC may also obtain power through the PCIe connector. The power port configured to be connected to the external power source may further be included on the PCIe card in an embodiment. As such, each of the elements on the PCIe card may also obtain necessary power from the external power source through the power port. Nevertheless, the invention sets no limit herein to the form that the heating device FC is implemented in.

In this embodiment, the loading device LC includes the controller 123, the controllable loading element 160, and the connection interface CI, wherein the controller 123 is coupled to the controllable loading element 160 and the connection interface CI.

In an embodiment, the loading device LC, for example, is implemented in the form of the PCIe card, so as to be conveniently disposed on the mainboard of the tested system. To be specific, the controller 123, the controllable loading element 160, and the connection interface CI are all disposed on the PCIe card, and the PCIe card may be inserted and disposed on the mainboard through the PCIe connector thereof. Accordingly, if a power supply is provided in the tested system to provide power to the mainboard, the loading device LC may also obtain power through the PCIe connector. The power port configured to be connected to the external power source may further be included on the PCIe card in an embodiment. As such, each of the elements on the PCIe card may also obtain necessary power from the external power source through the power port. Nevertheless, the invention sets no limit herein to the form that the loading device LC is implemented in.

Particularly, the fan control device FC acts as a master card in this embodiment. The controller 121 performs wired or wireless communication with an external electronic device ED first through the communication element 110 and then communicates with the controller 122 and the controller 123 through the connection interfaces CI.

For instance, the electronic device ED, for example, sends a fan control signal, a heating control signal, or a loading control signal to the communication element 110. When determining that the fan control signal is the signal received by the communication element 110, the controller 121 directly controls the fan connected thereto through the connector 130. When determining that the heating control signal is the signal received by the communication element 110, the controller 121 transmits the heating control signal to the controller 122 through the connection interface CI. When determining that the loading control signal is the signal received by the communication element 110, the controller 121 transmits the loading control signal to the controller 123 through the connection interface CI. In another aspect, when transmitting messages to the electronic device ED, the controller 122 and the controller 123 also transmit the messages to the controller 121 first through the connection interfaces CI and then transfer the messages to the electronic device ED.

Note that the fan control device FC acts as the master card for illustration in this embodiment, but the invention is not limited to the above. In other embodiments, the communication element 110, for example, may also be disposed at the heating device HC, and the heating device HC acts as the master card. Alternatively, the communication element 110, for example, is disposed at the loading device LC, and the loading device LC acts as the master card.

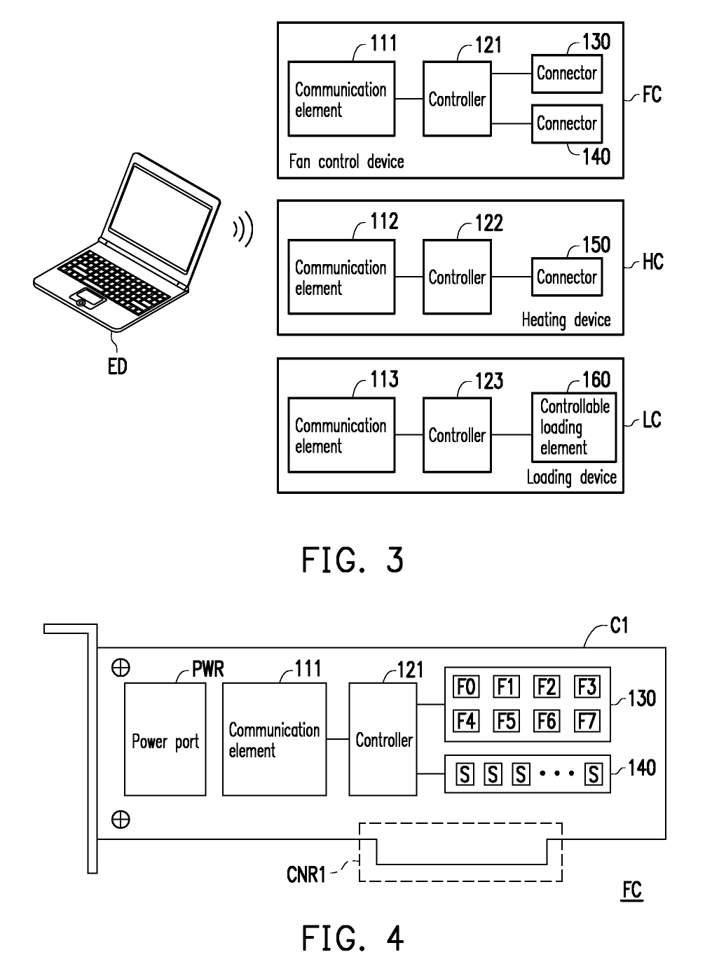

FIG. 3 illustrates a schematic diagram of a thermal simulation system according to an embodiment of the invention.

With reference to FIG. 3, another implementation of the thermal simulation system 100 in the embodiment of FIG. 1 is exemplarily introduced in this embodiment. Reference numerals in this embodiment which are the same as or similar to those in the previous embodiment are used to represent identical or similar elements, and thus, no further description is provided hereinafter.

Similar to the thermal simulation system 100 of the embodiment of FIG. 2, the thermal simulation system 100 of this embodiment also includes the fan control device FC, the heating device HC, and the loading device LC respectively controlled by the controller 121, the controller 122, and the controller 123. A difference therebetween includes that a communication element 111, a communication element 112, and a communication element 113 are respectively disposed on the fan control device FC, the heating device HC, and the loading device LC in this embodiment. As such, the fan control device FC, the heating device HC, and the loading device LC may operate individually and independently, without distinction of the master card and the non-master cards. In this embodiment, the communication elements 111, 112, and 113 are all similar to the communication element 110 in the embodiment of FIG. 1 and FIG. 2, and a relevant description thereof is thus omitted.

For instance, when the electronic device ED wirelessly sends the fan control signal, the controller 121 receives the fan control signal through the communication element 111 and controls the fan speed of the fan connected to the connector 130 according to the fan control signal. When the electronic device ED wirelessly sends the heating control signal, the controller 122 receives the heating control signal through the communication element 112 and controls a heat energy generated by the heating element connected to the connector 150 according to the heating control signal. When the electronic device ED wirelessly sends the loading control signal, the controller 123 receives the loading control signal through the communication element 113 and controls the loading value of the loading provided by the controllable loading element 160 according to the loading control signal. The fan control device FC, the heating device HC, and the loading device LC of this embodiment are respectively described in detail with reference to the drawings as follows.

FIG. 4 illustrates a schematic view of a fan control device according to an embodiment of the invention.

With reference to FIG. 4, the fan control device FC of this embodiment is implemented in the form of the PCIe card, and a PCIe card C1 is thus included. A power port PWR, the communication element 111, the controller 121, the connector 130, and the connector 140 of the fan control device FC are all disposed on the PCIe card C1. As shown in FIG. 3, the communication element 111 of this embodiment may be configured to communicate with the external electronic device ED.

In this embodiment, the connector 130 includes a plurality of (e.g., 8) fan ports F0 to F7, and each of the fan ports F0 to F7 is configured to be connected to one fan. When the communication element 111 receives the fan control signal from the electronic device ED, the controller 121 respectively controls the fan speeds of the fans according to the fan control signal. The fan control signal, for example, directly specifies a switch and the fan speed of each of the fans in an embodiment. Accordingly, the fan control device FC is capable of controlling the fan speed of each of the fans accurately. People having ordinary skill in the art shall know how the controller is implemented to control the fan speeds of the fans, and a relevant description thereof is thus omitted. In another aspect, the controller 121 may also read the fan speed of each of the fans through the connector 130 and transmit the fan speed of each of the fans to the electronic device ED through the communication element 111 as required.

The connector 140 includes a plurality of sensor ports S respectively configured to be connected to the temperature sensors in this embodiment. The temperature sensors, for example, are implemented as thermocouples in an embodiment, but the invention is not limited to the above. The controller 121, for example, is able to immediately transmit a temperature sensed by each of the temperature sensors to the electronic device ED through the communication element 111.

In this embodiment, the PCIe card C1 includes a PCIe connector CNR1 configured to be connected to a PCIe slot on the mainboard of the tested system. Accordingly, when a power supply is provided in the tested system to provide power to the mainboard, each of the elements on the fan control device FC and the fan connected thereto may all obtain power through the PCIe connector CNR1.

Note that the power port PWR is further included on the fan control device FC of this embodiment, and the power port PWR is disposed on the PCIe card C1 and is configured to be connected to the external power source. Accordingly, each of the elements on the fan control device FC and the fan connected thereto may obtain power from the external power source through the power port PWR.

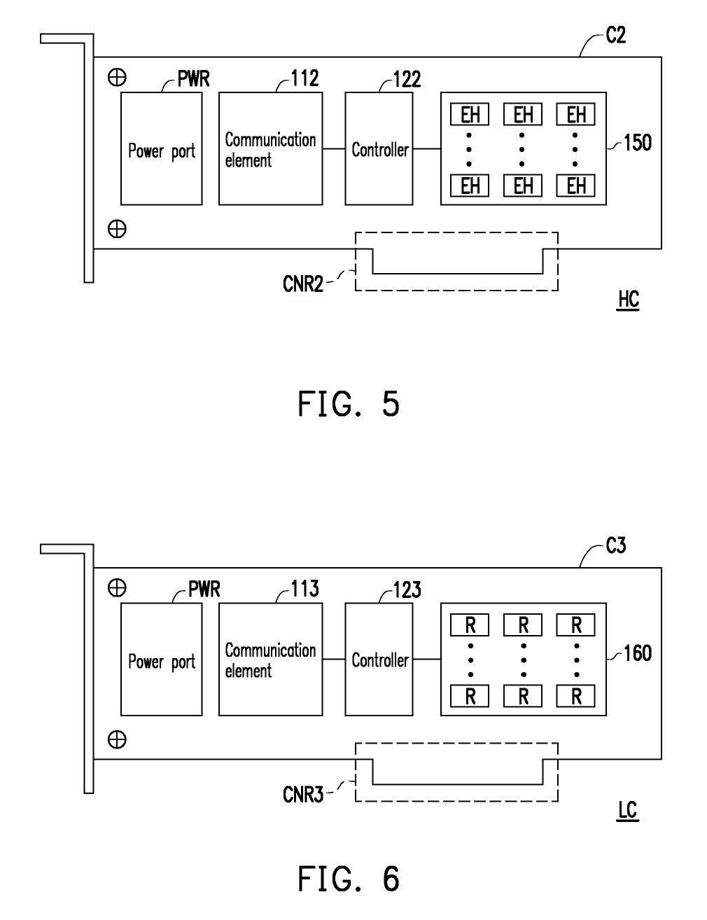

FIG. 5 illustrates a schematic view of a heating device according to an embodiment of the invention.

With reference to FIG. 5, the heating device HC of this embodiment is implemented in the form of the PCIe card, and a PCIe card C2 is thus included. The power port PWR, the communication element 112, the controller 122, and the connector 150 of the heating device HC are all disposed on the PCIe card C2. As shown in FIG. 3, the communication element 112 of this embodiment may be configured to communicate with the external electronic device ED.

The connector 150 includes a plurality of heating ports EH respectively configured to be connected to the heating elements in this embodiment. The heating elements, for example but not limited to, are implemented as electric heating pieces in an embodiment, and the heat energy generated by the heating elements may be adjusted through adjusting voltages applied to the electric heating pieces. As such, when the communication element 112 receives the heating control signal from the electronic device ED, the controller 122 respectively sets the voltage applied to each of the electric heating pieces through the heating ports EH in the connector 150 according to the heating control signal, so as to control the heat energy generated by the heating elements. In an embodiment, the heating control signal, for example, directly specifies a voltage value of the voltage applied to each of the electric heating pieces. Accordingly, the heating device HC is capable of accurately controlling the heat energy generated by the heating elements (or the electric heating pieces).

In this embodiment, the PCIe card C2 includes a PCIe connector CNR2 configured to be connected to the PCIe slot on the mainboard of the tested system. Accordingly, when a power supply is provided in the tested system to provide power to the mainboard, each of the elements on the heating device HC and the heating element connected thereto may all obtain power through the PCIe connector CNR2.

Note that the power port PWR is further included on the heating device HC of this embodiment. The power port PWR is disposed on the PCIe card C2 and is configured to be connected to the external power source. Accordingly, each of the elements on the heating device HC and the heating element connected thereto may obtain power from the external power source through the power port PWR.

FIG. 6 illustrates a schematic view of a loading device according to an embodiment of the invention.

With reference to FIG. 6, the loading device LC of this embodiment is implemented in the form of the PCIe card, and a PCIe card C3 is thus included. The power port PWR, the communication element 113, the controller 123, and the controllable loading element 160 of the loading device LC are all disposed on the PCIe card C3. As shown in FIG. 3, the communication element 113 of this embodiment may be configured to communicate with the external electronic device ED.

The controllable loading element 160 includes a plurality of resistors R and a switch corresponding to each of the resistors R in this embodiment. The loading value of the loading provided by the controllable loading element 160 may be correspondingly set by adjusting the switches. Note that the resistors R may be identical or different. Moreover, each of the resistors R may be implemented through a cement resistor, a SWD resistor, or other similar resistors, and the invention is not limited to the above. As such, when the communication element 113 receives the loading control signal from the electronic device ED, the controller 123 controls the switches corresponding to the resistors R according to the loading control signal, so as to set the loading value of the loading provided by the controllable loading element 160. In an embodiment, the loading control signal, for example, directly specifies the loading value, and the controller 123 determines and controls the switches corresponding to the resistors R according to the specified loading value. Accordingly, the loading device LC is able to accurately control the loading value of the loading provided by the controllable loading element 160.

In this embodiment, the PCIe card C3 includes a PCIe connector CNR3 configured to be connected to the PCIe slot on the mainboard of the tested system. Accordingly, when a power supply is provided in the tested system to provide power to the mainboard, each of the elements on the loading device LC may obtain power through the PCIe connector CNR3.

Note that the power port PWR is further included on the loading device LC of this embodiment, and the power port PWR is disposed on the PCIe card C3 and is configured to be connected to the external power source. Accordingly, each of the elements on the loading device LC may obtain power from the external power source through the power port PWR.

The fan control device FC, the heating device HC, and the loading device LC described in this embodiment can operate individually and independently. Therefore, in other embodiments, the testing personnel may also arbitrarily select one of the fan control device FC, the heating device HC, and the loading device LC or a combination of the foregoing for building the thermal simulation system as required.

In addition, the communication elements 111, 112, and 113 may be connected to through using a hand-held remote control with, for example, an infrared module (e.g., a RF Sub-1 GHz module) by the testing personnel in an embodiment. As such, the test personnel may remotely control the thermal simulation system or obtain various information of the thermal simulation system more conveniently through using the hand-held remote control.

In view of the foregoing, in the thermal simulation system provided by the embodiments of the invention, the controller is used to respectively control the fan, the temperature sensor, the heating element, and the controllable loading element, so as to more accurately control the fan speed of the fan, the heat energy generated by the heating element, and the loading value of the loading provided by the controllable loading element when thermal testing is performed in the system. Accordingly, the testing personnel may create the test environment required more conveniently.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A thermal simulation system, adapted to establish a test environment for a thermal test, the thermal simulation system comprising:
a communication element, configured to receive at least one of a heating control signal, a fan control signal, and a loading control signal from an external electronic device;
a controllable loading element, configured to provide a loading;
a plurality of connectors, configured to connect a heating element and a fan; and
a controller, coupled to the communication element, the connectors, and the controllable loading element,
wherein the controller is configured to control a heat energy generated by the heating element according to the heating control signal, control a fan speed of the fan according to the fan control signal, and control a loading value of the loading provided by the controllable loading element according to the loading control signal.

2. The thermal simulation system as claimed in claim 1, further comprising:
a PCIe card, comprising a PCIe connector, wherein the communication element, the controllable loading element, the connectors, and the controller are disposed on the PCIe card, and the communication element, the controllable loading element, the heating element, the fan, and the controller obtain power through the PCIe connector.

3. The thermal simulation system as claimed in claim 1, further comprising:
a power port, coupled to the communication element, the controllable loading element, the connectors, and the controller and configured to be connected to an external power source, wherein the communication element, the controllable loading element, the heating element, the fan, and the controller obtain power from the external power source through the power port.

4. The thermal simulation system as claimed in claim 1, wherein the communication element comprises at least one of a Wi-Fi communication module or an infrared communication module.

5. The thermal simulation system as claimed in claim 1, wherein the heating element comprises a plurality of electric heating pieces, wherein the controller is configured to set voltages respectively applied to the electric heating pieces according to the heating control signal to control the heat energy generated by the heating element.

6. The thermal simulation system as claimed in claim 1, wherein the controllable loading element comprises a plurality of resistors and a plurality of switches corresponding to the resistors,
wherein the controller is configured to control the switches according to the loading control signal to set the loading value of the loading provided by the controllable loading element.

7. A thermal simulation system, adapted to establish a test environment for a thermal test, the thermal simulation system comprising:
a first communication element, configured to receive a heating control signal from an external electronic device;
a first connector, configured to connect a heating element; and
a first controller, coupled to the first communication element and the first connector and configured to control a heat energy generated by the heating element according to the heating control signal.

8. The thermal simulation system as claimed in claim 7, further comprising:
a PCIe card, comprising a PCIe connector, wherein the first communication element, the first connector, and the first controller are disposed on the PCIe card, and the first communication element, the first heating element, and the first controller obtain power through the PCIe connector.

9. The thermal simulation system as claimed in claim 7, further comprising:
a power port, coupled to the first communication element, the first connector, and the first controller and configured to be connected to an external power source, wherein the first communication element, the heating element, and the controller obtain power from the external power source through the power port.

10. The thermal simulation system as claimed in claim 7, wherein the first communication element comprises one of a Wi-Fi communication module or an infrared communication module.

11. The thermal simulation system as claimed in claim 7, wherein the heating element comprises a plurality of electric heating pieces, wherein the first controller is configured to set voltages respectively applied to the electric heating pieces according to the heating control signal to control the heat energy generated by the heating element.

12. The thermal simulation system as claimed in claim 7, further comprising:
a second communication element, configured to receive a fan control signal from the external electronic device;
a second connector, configured to connect a fan; and
a second controller, coupled to the second communication element and the second connector and configured to control a fan speed of the fan according to the fan control signal.

13. The thermal simulation system as claimed in claim 7, further comprising:
a third communication element, configured to receive a loading control signal from the external electronic device;
a controllable loading element, configured to provide a loading; and
a third controller, coupled to the third communication element and the controllable loading element and configured to control a loading value of the loading provided by the controllable loading element according to the loading control signal.

14. A thermal simulation system, adapted to establish a test environment for a thermal test, the thermal simulation system comprising:
a first communication element, configured to receive a loading control signal from an external electronic device;
a controllable loading element, configured to provide a loading; and
a first controller, coupled to the first communication element and the controllable loading element and configured to control a loading value of the loading provided by the controllable loading element according to the loading control signal.

15. The thermal simulation system as claimed in claim 14, further comprising:
a PCIe card, comprising a PCIe connector, wherein the first communication element, the controllable loading element, and the first controller are disposed on the PCIe card, and the first communication element, the controllable loading element, and the first controller obtain power through the PCIe connector.

16. The thermal simulation system as claimed in claim 14, further comprising:
a power port, coupled to the first communication element, the controllable loading element, and the first controller and configured to be connected to an external power source, wherein the first communication element, the controllable loading element, and the first controller obtain power from the external power source through the power port.

17. The thermal simulation system as claimed in claim 14, wherein the first communication element comprises one of a Wi-Fi communication module or an infrared communication module.

18. The thermal simulation system as claimed in claim 14, wherein the controllable loading element comprises a plurality of resistors and a plurality of switches corresponding to the resistors,
wherein the first controller is configured to control the switches according to the loading control signal to set the loading value of the loading provided by the controllable loading element.

19. The thermal simulation system as claimed in claim 14, further comprising:
a second communication element, configured to receive a fan control signal from the external electronic device;
a second connector, configured to connect a fan; and
a second controller, coupled to the second communication element and the second connector and configured to control a fan speed of the fan according to the fan control signal.
